(19) United States
(12) Patent Application Publication
(10) Pub. No.: US 2007/0278268 A1
(43) Pub. Date: Dec. 6, 2007

(54) Flash fire protection

(75) Inventor: Russell A. Monk, Salem, OR (US)

Correspondence Address: ROBERT D. VARITZ, P.C., 4915 SE 33RD PLACE, PORTLAND, OR, 97202, US

(73) Assignee: High Impact Technology, L.L.C.

(21) Appl. No.: 11/807,881

(22) Filed: May 30, 2007

Related U.S. Application Data
(60) Provisional application No. 60/809,802, filed on May 30, 2006.
(60) Provisional application No. 60/814,629, filed on Jun. 15, 2006.

(51) Int. Cl. B26B 29/02

(52) U.S. Cl. 224/232

(57) ABSTRACT

Sheath structure for flash-fire pressure-wave protecting a selected, contained utility tool or device including a fabric sheath jacket formed of a fibre-strand-reinforced silicone foam material, and a sheath pocket defined by that jacket, and sized for freely receiving such a tool or device. The silicone foam jacket is capable of sustaining it own structural integrity when exposed for a time period of up to about 10-minutes to an external, flash-fire pressure-wave proximity temperature of up to about 1000-degrees Fahrenheit.

### CROSS REFERENCE TO RELATED APPLICATIONS

This application claims priority to prior-filed, currently co-pending U.S. Patent Applications Ser. Nos. 60/809,802 filed May 30, 2006, for “Flash Fire Protection” and 60/814,689, filed Jun. 15, 2006 for “Flash Fire Protection. The entire disclosure contents of these two Provisional Patent Applications are hereby incorporated herein by reference.

### BACKGROUND AND SUMMARY OF THE INVENTION

The present invention concerns what is referred to herein as a sheath structure for protecting a guarded device, such as a utility tool, or another piece, or pieces, of personally carried equipment, against catastrophic overheating in a flash fire pressure-wave event—an event involving a sudden application (wave-like in nature) of intense, and relatively short-duration (but perhaps as long as about 10-minutes) heat from a fire, such as from an explosion-produced fire, which can raise temperatures easily up to near 1,000-degrees Fahrenheit.

While the creation of this invention was specifically triggered by recognizing the existence of a serious problem which is currently being encountered in a military combat zone in the Middle East involving planted explosive devices which are set off to create large and extremely dangerous life-threatening explosions characterized by the flash-fire pressure-wave phenomenon generally mentioned above, the invention also addresses the mentioned “device-guarding” issue with respect to other settings and other types of flash-fire pressure-wave events, such as might occur during a forest fire, or as triggered by an explosion onboard a water vessel.

It should also be understood that the terms “sheath” and “sheath structure” used herein are intended to mean any kind of personnel-carried enclosure structure which might “house” that which is referred to herein as a guarded device, or tool. For examples, knife sheaths, and other “hand-tool” sheaths, are contemplated to be among such sheath structures, as are also backpacks, fanny-packs, belt-packs, etc. Simply for convenient explanation purposes a preferred and best mode embodiment of the invention is illustrated and described herein principally in the realm of hand-tool sheaths, such as knife sheaths, though one will readily observe that various ones of the several drawing figures can be read as illustrating other kinds of “sheaths”, such as a “backpack” sheath, a fragmentary representation of which is pictured specifically in one of these figures.

Speaking now in the realm of personal utility-tool carrying sheaths, personnel engaged in activities taking place in the settings of flash-fire pressure-wave events of the type mentioned above, also referred to herein as flash-fire events, often carry sheathed utility tools, such as knives, cutters, flashlights and pliers, etc. Assuming that such personnel have, by wearing appropriate, conventional protective garments, survived a flash-fire occurrence (event), they may need to have safe and quick access to their own tools immediately after a flash-fire event. For example, and in the case of a knife being the sheathed device, they may need to have such access to cut away burning or damaged clothing. Additionally, other personnel who may need to act quickly to attend to a flash-fire-injured person carrying such a tool, may also need to have safe, and immediate access to that injured party's sheathed tool.

In such a condition, it is critical that a flash-fire event not be permitted catastrophically to overheat such a tool to a dangerously high temperature—i.e. to a temperature with respect to which a seriously overheated tool simply cannot be safely handled, or might be irreparably damaged/decommissioned.

This invention addresses such a problem in a manner which does not negatively alter other sheathed, utility-tool-carrying considerations, such as, in a military setting, sheath-surface-prepared IR and visual camouflaging characteristics (qualities) typically required for sheathed combat knives carried by soldiers.

For invention-description and illustration purposes herein, a preferred and best mode embodiment of the invention, and several modifications thereof, are specifically set forth in the military setting of high-temperature-protecting a sheathed combat knife—a setting wherein the invention has been found to offer particular utility.

Accordingly, in the case of a soldier's combat knife, a sheath structure, in a related, preferred form of the invention, is proposed which includes an outer fabric sheath envelope suitably formed of an appropriate, combined, visual and IR outer-surface-camouflaged material, such as an outer-surface-camouflaged Cordura® nylon material. This envelope includes a pocket that receives a fabric sheath jacket formed of a high-temperature-guarding, fibre-strand-reinforced silicone foam material. A protected combat knife fits inside a pocket formed by the sheath jacket.

Sheath-envelope material of the type just mentioned is referred to herein as being a sacrificial fabric material which will typically be destroyed in a flash fire event. Surface-prepared visual and IR camouflaging are referred to herein as being material-surface qualities.

In another embodiment of the invention, the proposed sheath structure takes the form, essentially, of a single-fabric-component construction, wherein the outer surface of a fibre-strand-reinforced silicone foam material—a sheath jacket—is configured to supply, per se, at least one of (a) visual and (b) IR, camouflaging (i.e., camouflage qualities). This invention embodiment does not employ an outer sheath envelope.

In many embodiments, of course, no outside-surface camouflaging is employed.

In still a third embodiment of the invention, there are provided two temperature-guarding sheath jackets received within a sacrificial-material sheath envelope.

In a backpack, fanny-pack, belt-pack situation, it might typically be the case that only a single “sheath jacket” high-temperature-guarding structure is employed—such being used to form the fabric body of such a pack.

With respect specifically to recently constructed and tested military-combat-knife sheath structures of the natures just generally mentioned above, testing has indicated that, while an employed, sheath envelope, of the type mentioned above, indeed becomes a sacrificial structure during a flash-fire pressure-wave event, the silicone-foam-material sheath jacket structure stays completely intact, even though such a pressure wave event, coupled with the attendant, extraordinarily high temperatures, exerts extreme “forces” on whatever it encounters, effectively guarding a contained combat knife to a temperature rise which is no more than about 100-degrees Fahrenheit—a temperature which allows for relatively immediate handling of such a knife after a flash-fire event. Such “temperature guarding” occurs reliably even in a circumstance wherein a flash-fire event (as may often be the case) creates, with very high pressure-wave force, an immediate outside temperature (referred to herein as a proximity temperature) of up to about 1000-degrees Fahrenheit, with this temperature lasting for a time period as long as, or up to, about 10-minutes.

These important features and advantages of the invention will become more fully apparent as the description thereof which now follows is read in conjunction with the accompanying drawings.

### DESCRIPTION OF THE DRAWINGS

FIG. 1 is a simplified, schematic side elevation, with portions broken away to illustrate details of construction, of flash-fire-protection sheath structure constructed in accordance with a preferred embodiment of the invention, illustrated in a configuration wherein it is holding and protecting a military combat knife.

FIG. 2 is an enlarged, simplified, schematic cross section taken generally along the line 2-2 in FIG. 1.

FIG. 3 is a fragmentary, stylized view generally taken in the area in FIG. 2 which is embraced by a pair of curved arrows 3-3 in FIG. 2 and rotated 90° counter-clockwise.

FIG. 4 is a simplified, fragmentary side elevation of a backpack sheath structure, with a portion broken away to reveal details of construction.

FIG. 5 is similar to FIG. 1, except that it shows one modified form of sheath structure made in accordance with the present invention.

FIG. 6 is a view which is similar to that presented in FIG. 3, with the exception that it illustrates features of the sheath modification shown in FIG. 5.

FIG. 7 is a view which is similar in nature to FIGS. 3 and 5 illustrating yet another modified form of sheath structure made in accordance with this invention.

### DETAILED DESCRIPTION OF THE INVENTION

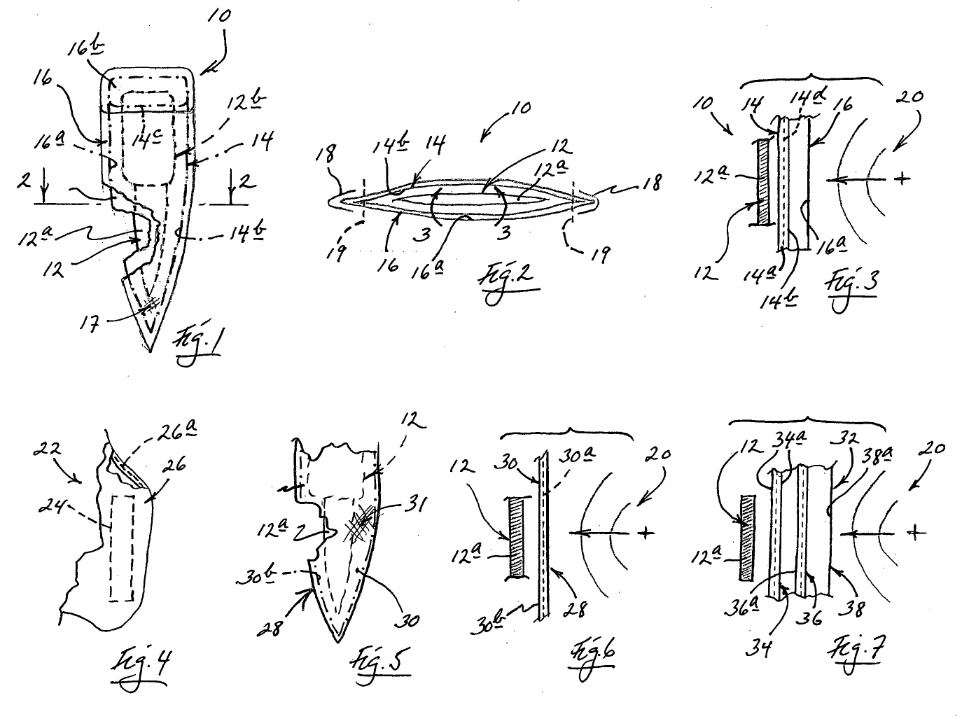

Turning now to the drawings, and referring first of all to FIGS. 1-3, inclusive, indicated generally at 10 in these figures is flash-fire-protecting sheath structure, or sheath, made in accordance with a preferred embodiment of the present invention. Sheath 10 is illustrated in these figures in a condition providing flash-fire-protection for an encased military combat knife 12 having a blade 12a and a handle 12b. Knife 12 is also referred to herein both as a utility tool, and as a utility device, and is constructed of materials which are capable of holding heat when exposed to an ambient temperature rise. Knife 12 is illustrated fragmentarily and schematically in FIG. 3.

It should be understood, as was mentioned earlier herein, that while the sheath structure of this invention is now being specifically illustrated and described in the setting of providing flash-fire pressure-wave protection for a military combat knife, the sheath structure of this invention may be designed to accommodate, and to provide flash-fire protection for, a very wide variety of other utility tools, and other devices, such as the several such tools which were mentioned earlier herein. Obviously, the overall configuration of a sheath structure designed to provide protection for a particular type of utility device or tool will often be shaped appropriately to receive that tool, and such shaping in sheath 10 for combat knife 12 is clearly evident particularly in FIG. 1 in the drawings.

With regard to the specific components illustrated in FIGS. 1-3, inclusive, that make up sheath structure 10, these components include a high-temperature-guarding, fibre-strand-reinforced, fabric sheath jacket 14 having a main body 14a which contains/defines a sheath pocket 14b that directly receives knife 12, and which main body includes an upper, fold-over, pocket-closure flap 14c. Fibre-strand reinforcement in jacket 14 takes the form herein of an internal weave 14d of e-glass fibre strands (shown by a dashed line in FIG. 3). Other very suitable fibre reinforcement may be provided by fibreglass strands, and by aramid-material fibre strands.

The high-temperature-guarding, pressure-wave-resisting main body 14a in sheath jacket 14 is formed specifically of a material which is capable of sustaining structural integrity even when it is exposed, in a powerful pressure wave, to what is referred to herein as a proximity temperature, i.e., a temperature immediately adjacent its outside surface, of up to about 1,000-degrees Fahrenheit for a period of time of up to about 10-minutes. Such a material herein takes the form of elastomeric silicone foam, with this foam material, in jacket structure 14, having a thickness lying preferably in the range of about 0.03-inches to about 0.04-inches.

Significantly, not only is this sheath jacket body material capable of sustaining structural integrity, aided by the internal presence of fibre-strand reinforcement, under the conditions just described, it is also capable, under the same conditions, of limiting, to a temperature of no more than about 100-degrees Fahrenheit, the temperature rise experienced by the handle and blade in knife 12—a temperature which is easily tolerated by the human hand.

Also included among the sheath-structure components in the invention embodiment of FIGS. 1-3, inclusive, is an outer sheath envelope 16 which includes/defines a pocket 16a that directly receives sheath jacket 14, per se, with the sheath envelope thus having a configuration which is larger than, but otherwise shaped somewhat like, sheath jacket 14. As is the case with sheath jacket 14, sheath envelope 16 includes a fold-over, upper, pocket-closure flap 16b.

Sheath envelope 16 is preferably formed of Cordura® nylon, a material which is referred to herein as a flash-fire sacrificial fabric material, having a thickness lying in the range of about 0.04-inches to about 0.05-inches, and featuring a Denier linear-density rating lying in the range preferably of about 200 to about 1,000. The word Cordura® is a registered trademark owned by a company known as Invista which has a North American office in Wilmington, Del. Cordura® nylon is, of course, a well known nylon product.

Preferably, while this nylon sheath envelope is indeed a flash-fire sacrificial material, up to the point of being sacrificed and destroyed during a flash-fire, or during a like event, it presents on its outer surface at least one of, and preferably both, conventional, surface-prepared, visual and IR camouflaging quality(ies) 17 of the kind(s) typically recommended for and employed in military knife sheaths.

As indicated generally at two dashed-line locations marked 18 in FIG. 2, further included in sheath 10 are suitable, fabric, edge-bindings, formed of a material, which may also be a Cordura® nylon material, which binding material is stitched to the two, opposite, lateral edges of sheath structure 10. Stitching for these edge-bindings is shown in dashed lines at 19 in two locations in FIG. 2.

Illustrated schematically and generally at 20 in FIG. 3 is a representative flash-fire pressure-wave event which “strikes” the outer surface of sheath envelope 16 with a powerful, and potentially pressure-damaging, wavelike action, as is suggested by the curved lines and the leftward pointing arrow appearing in FIG. 3. As has been mentioned earlier herein, such a flash-fire wave can create, in addition to a powerful shock event, a dangerous proximity temperature adjacent the outside surface of structure 10 of up to about 1000-degrees Fahrenheit, with, in certain circumstances, this temperature condition lasting for a time period of up to about 10-minutes. Testing, under these conditions, of a knife sheath constructed as described for sheath 10 herein has established clearly that, while sheath envelope is quickly destroyed, sheath jacket 14 maintains its structural integrity. Most importantly, given the stated, preferred thickness range for the silicone foam material employed in jacket main body 14a, even at the thinnest level of this range, the temperature rise occurring for and in the handle and blade of a protected knife, such as knife 12, has been found to reach an upper temperature limit of only about 100-degrees Fahrenheit.

As a significant consequence of this pressure-wave-protective and temperature-protective behavior, substantially immediately after the occurrence of such a flash-fire event, followed, of course, by an appropriate subsidence of the mentioned flash-fire-produced, high, proximity, outside temperature, i.e., when a subject sheath can safely be reached without personal, physical “outside-temperature harm”, the protected knife (or whatever else might be the specific protected tool or device) can be removed from the sheath, and handled easily and comfortably.

Focusing attention now to FIG. 4, here there is shown fragmentarily at 22 a backpack in which is carried a to-be-protected device 24, such as a GPS position tracking and reporting device. The outer “bag” part of this backpack herein is formed of a sheath-structure jacket 26 which is made of the same fibre-strand-reinforced, high-temperature-guarding silicone foam material described above for previously mentioned sheath jacket 14. Internal fibre reinforcing in jacket 26 is provided by a weave 26a of e-glass. No outer sheath envelope is provided in backpack 22.

FIGS. 5 and 6 in the drawings illustrate another knife-sheath-structure form 28 of the invention which does not include a sheath envelope. Sheath structure 28 includes a sheath jacket 30 which is otherwise like previously described sheath jacket 14, with the exception that the outer surface of jacket 30 itself has been prepared with one or both of the surface qualities mentioned earlier as being visual and/or IR camouflaging qualities 31. Fibre-strand-reinforcement in jacket 30 takes the form of a weave 30a of e-glass strands.

In FIG. 5, previously mentioned knife 12 is seen to be contained within a pocket 30b which is formed in and defined by sheath jacket 30. This same knife is illustrated fragmentarily and schematically in FIG. 6.

The performance of sheath structure 28 is very similar to that described for sheath structure 10, except for the fact that sheath structure 28 does not include an outer sacrificial-fabric sheath envelope.

Addressing now what is pictured in FIG. 7, here there is shown generally at 32 still another modified form of the sheath structure of this invention. Sheath structure 32 differs from the other sheath structures described hereinabove, in that it includes two sheath jackets 34 (inner), 36 (outer), and additionally, an outside sheath envelope 38. previously mentioned knife 12 appears schematically in this figure in the same manner that it appears in previously discussed FIGS. 3 and 5. Knife 12 specifically is contained within a pocket 34a which is furnished by inner sheath jacket 34. Sheath jacket 34 is received within a pocket 36a which is provided in outer sheath jacket 36. The combination of sheath jackets 34, 36 is received within a pocket 38a which is provided sheath envelope 38.

The outside surface of sheath envelope 38 is prepared to possess one or both visual and/or IR camouflaging qualities.

Sheath jackets 34, 36 are constructed in the same manner, and with the same silicon foam material employed in, previously discussed sheath jackets 14, 26. Sheath structure 32 functions in the presence of a flash-fire in manner which is similar to the functioning described for sheath structure 10, with the exception that the two, nested sheath jackets provide a double layer of temperature isolation for a contained utility tool, such as knife 12.

There have thus been described hereinabove a novel sheath structure for holding a utility tool, and for furnishing significant temperature-rise control with respect to that tool in the presence of a flash-fire pressure-wave event having the characteristics mentioned earlier herein. Immediately after such a flash-fire event, as was described earlier, anyone seeking to gain access to a tool or other device contained by the sheath structure of this invention will be able easily to handle that tool or device without fear of burning and injury to the hand.

Accordingly, while a preferred embodiment, and certain modifications, of the invention have been illustrated and described herein, other variations and modifications may certainly be made which will come within the spirit and scope of the invention.

I claim:

1. Sheath structure for flash-fire pressure-wave-protecting a selected, contained utility tool or device comprising
a sheath jacket formed of a fibre-strand-reinforced silicone foam material, and
a sheath pocket defined by said jacket, sized for freely receiving such a tool or device.

2. The sheath structure of claim 1, wherein said jacket has an outside surface prepared with at least one of (a) visual, and (b) IR, camouflage qualities.

3. The sheath structure of claim 1, wherein the material forming said jacket is constructed (a) to retain structural integrity in the presence of a flash-fire pressure wave which produces an external proximity temperature of up to about 1000-degrees Fahrenheit, which temperature may last for a time period of up to about 10-minutes, and (b) to prevent, during that same time period, a temperature rise to more than about 100-degrees Fahrenheit in a tool or device then received in said pocket.

4. The sheath structure of claim 3, wherein the material forming said jacket has a thickness lying in the range of about 0.03-inches to about 0.04-inches.

5. The sheath structure of claim 1, wherein the mentioned fibre-strand-reinforcement provided for said jacket is provided by strands of at least one of e-glass, fiberglass, and aramid material.

6. The sheath structure of claim 1, which further comprises a sheath envelope encompassing said jacket, and having an outside surface which is prepared with at least one of (a) visual, and (b) IR, camouflage qualities.

7. The sheath structure of claim 6, wherein said envelope is formed from a flash-fire sacrificial fabric material.

8. The sheath structure of claim 7, wherein said sacrificial fabric material takes the form of Cordura® nylon having a thickness lying in the range of about 0.04-inches to about 0.05-inches, and a Denier rating in the range of about 200 to about 1000.

9. Flash-fire pressure-wave-protecting sheath structure for a utility tool or device comprising
a sheath jacket having opposite sides, and formed from a material capable of maintaining structural integrity when exposed, on one of its sides, to a flash-fire pressure-wave proximity temperature of up to about 1000-degrees Fahrenheit for a time period of up to about 10-minutes, while resisting, immediately adjacent its other, opposite side, a temperature rise above about 100-degrees Fahrenheit, and
a utility-tool or device receiving sheath pocket defined by said jacket and immediately bounded and confrontingly faced by said jacket's said other, opposite side.

10. The sheath structure of claim 9 which further includes a sheath envelope formed from a flash-fire sacrificial fabric material, and including a pocket disposed in a condition receiving said sheath jacket.

11. Flash-fire pressure-wave protecting sheath structure for receiving and protectively encompassing the blade and handle of a military combat knife comprising
a sheath jacket formed of fibre-strand-reinforced silicone foam material capable of sustaining structural integrity when exposed for a time period of up to about 10-minutes to an external flash-fire pressure-wave proximity temperature of up to about 1000-degrees Fahrenheit, and
a combat knife pocket defined by said jacket.

12. The sheath structure of claim 11, wherein the mentioned fibre-strand-reinforcement provided for said jacket is provided by strands of at least one of e-glass, fiberglass, and aramid material.
